(19) United States
(12) Patent Application Publication
(10) Pub. No.: US 2008/0156549 A1
(43) Pub. Date: Jul. 3, 2008

(54) Ventilation for fuel cell power unit

(76) Inventors: David A. Leboe, Vancouver (CA); Kenneth W. Kratschmar, Vancouver (CA)

Correspondence Address: TROP PRUNER & HU, PC, 1616 S. VOSS ROAD, SUITE 750, HOUSTON, TX, 77057-2631, US

(21) Appl. No.: 11/821,707

(22) Filed: Jun. 25, 2007

Related U.S. Application Data
(60) Provisional application No. 60/805,848, filed on Jun. 26, 2006.

(51) Int. Cl. B60K 1/00

(52) U.S. Cl. 180/65.1; 429/12; 429/82

(57) ABSTRACT

A fuel cell-based system including equipment not classified to operate in a flammable environment, a detector to detect a flammable gas, and a component capable of leaking a flammable gas are arranged in an enclosure. The component is positioned above the unclassified equipment and below the sensor, and a buoyancy path is provided such that the unclassified equipment is isolated from flammable gas emitted by the component in the enclosure while a ventilation system is not energized. In addition, the detector is placed in the buoyancy path so that when the system is started from a de-energized state, the detector can determine whether an unacceptable concentration of flammable gas is present in the enclosure. When the system is energized, the ventilation system creates an air stream through the enclosure. The ventilation system is arranged such that unclassified equipment is upstream of flammable gas that is emitted by the component in the enclosure.

### CROSS REFERENCE TO RELATED APPLICATIONS

This application claims the benefit under 35 U.S.C. § 119(e) to U.S. Provisional Application Ser. No. 60/805,848, entitled “VENTILATION FOR FUEL CELL POWER UNIT,” which was filed on Jun. 26, 2006, and is hereby incorporated by reference in its entirety.

### BACKGROUND

The invention generally relates to a ventilation system for a fuel cell system.

A fuel cell is an electrochemical device that converts chemical energy directly into electrical energy. There are many different types of fuel cells, such as a solid oxide fuel cell (SOFC), a molten carbonate fuel cell, a phosphoric acid fuel cell, a methanol fuel cell and a proton exchange membrane (PEM) fuel cell.

As a more specific example, a PEM fuel cell includes a PEM membrane, which permits only protons to pass between an anode and a cathode of the fuel cell. A typical PEM fuel cell may employ polysulfonic-acid-based ionomers and operate in the 50° Celsius (C) to 75° temperature range. Another type of PEM fuel cell may employ a phosphoric-acid-based polybenziamidazole (PBI) membrane that operates in the 150° to 200° temperature range.

At the anode of the PEM fuel cell, diatomic hydrogen (a fuel) ionizes to produce protons that pass through the PEM. The electrons produced by this reaction travel through circuitry that is external to the fuel cell to form an electrical current. At the cathode, oxygen is reduced and reacts with the protons to form water. The anodic and cathodic reactions are described by the following equations:

H₂→2H⁺+2e⁻ at the anode of the cell, and Equation 1

O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) and to provide more power.

The fuel cell stack may include flow plates (graphite composite or metal plates, as examples) that are stacked one on top of the other, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Catalyzed electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

### SUMMARY

In accordance with one embodiment of the invention, a fuel cell system comprises an enclosure, a first subsystem not classified to operate in a flammable environment, a sensor to detect a flammable gas, and a component capable of emitting a flammable gas. The system further comprises a buoyancy path to guide flammable gas emitted in the enclosure such that the gas can buoyantly escape from the enclosure. The sensor is located in the buoyancy path, and the buoyancy path is arranged to substantially isolate the first subsystem from the flammable gas at least until the flammable gas reaches the sensor.

In accordance with another embodiment of the invention, a method usable with a fuel cell system comprises providing a first subsystem not classified to operate in a flammable environment, providing a sensor to detect a flammable gas, and providing a component capable of emitting a flammable gas. The method also comprises arranging the first subsystem, the sensor and the component in an enclosure such that the component is located above the first subsystem and below the sensor. A buoyancy path is provided to guide the emitted flammable gas out of the enclosure. The sensor is used to detect whether a concentration of the flammable gas in the buoyancy path exceeds a predefined threshold.

In accordance with yet another embodiment of the invention, a vehicle comprises a chassis and a fuel cell system. The fuel cell system comprises an enclosure, a first subsystem not classified to operate in a flammable environment, a sensor to detect a flammable gas, and a component capable of emitting a flammable gas. The first subsystem, the sensor, and the component are arranged in the enclosure such that, when the fuel cell system is supported by the chassis, a buoyancy path for the flammable gas to escape the enclosure is provided between the component and the sensor.

Advantages and other features of the invention will become apparent from the following drawing, description and claims.

### BRIEF DESCRIPTION OF THE DRAWING

FIG. 1 is a block diagram of a fuel cell-based system according to an embodiment of the invention.

FIG. 2 is a diagram showing an arrangement of various components and equipment of a fuel-cell based system in an enclosure and the emission of flammable gas within the enclosure while the system is de-energized, according to an embodiment of the invention.

FIG. 3 is a diagram showing the arrangement of FIG. 2 and illustrating a ventilation path through the enclosure while the system is energized, according to an embodiment of the invention.

### DETAILED DESCRIPTION

A fuel cell system may potentially be a hazardous location, and in accordance with this recognition, embodiments of fuel cell systems are disclosed herein for use in hazardous locations. Hazardous locations may be classified by classes and zones. In the context of this application, the fuel cell systems are designed for class one, which is the class for flammable gases.

Zone zero refers to an environment where ignitable concentrations of flammable gases, vapors or liquids are present continuously or for long periods of time under normal operating conditions. Zone one refers to an environment where ignitable concentrations of flammable gases, vapors or liquids are likely to exist under normal operating conditions. Zone two refers to an environment where ignitable concentrations of flammable gases, vapors or liquids are not likely to exist under normal operating conditions.

Each zone is associated with specific protection measures or design requirements. For example, for zone two, electrical protection techniques include using devices that are non-sparking, energy limited, hermetically sealed, non-incendiary, etc. Some components such as large batteries and sparking components do not meet the classification requirements and therefore, must be de-classified by means of ventilation or other techniques to ensure that the environment remains free of flammable gas. The fuel cell system described herein contains both unclassified and classified subsystems. In accordance with embodiments of the invention that are described herein, in order for the unclassified subsystem to startup, a ventilation fan to de-classify the unclassified subsystem is started up only after the classified system determines (by a sensor, for example) a flammable atmosphere does not exist.

Designing and qualifying components for classified environments may present various challenges, such as increased component costs and certification costs. For this reason, the fuel cell systems that are described herein have a combination of classified and unclassified components.

Because the anode chamber of the fuel cell stack may be purged and/or the stack itself may potentially leak or emit flammable gas during normal operation and/or a failure event occurs that results in an abnormal release of a flammable substance, flammable concentrations may be present at the start-up of the fuel cell system or during the fuel cell system's normal operation. To limit the extent of classified circuitry that is required for safe operation, a circuit for a fuel cell system that uses both unclassified and classified components is described herein in accordance with embodiments of the invention. Using this concept, a flexibility is provided to design the classified components to operate either in zone two, zone one or zone zero with minimal impact on the product design.

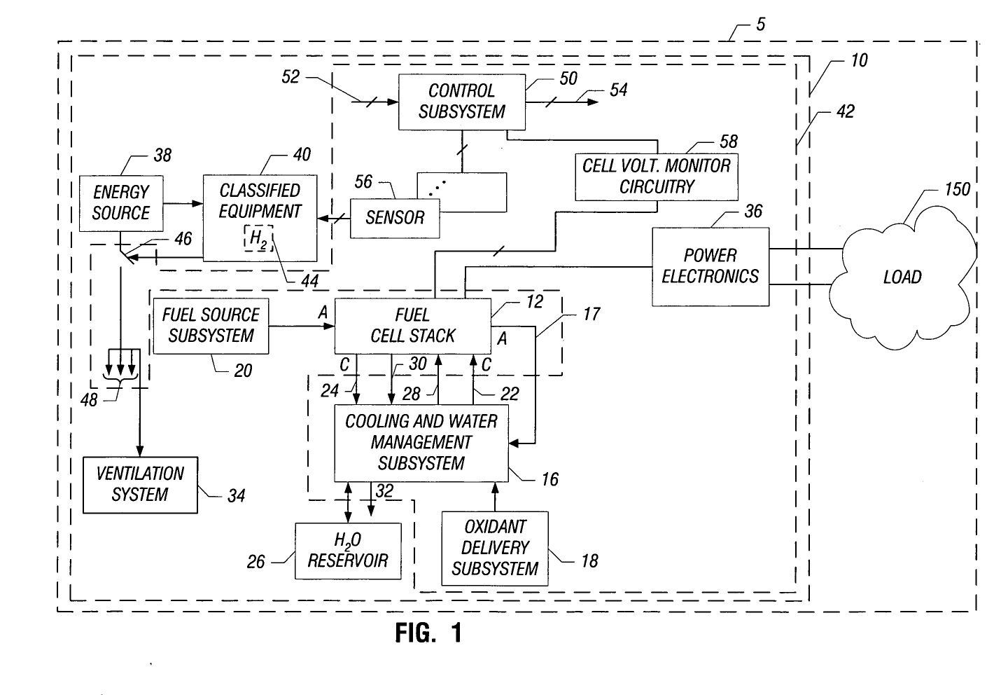

Referring to FIG. 1, an embodiment of a fuel cell-based system 10 in accordance with the invention includes a fuel cell stack 12, which generates electrical power for an external load 150. The load 150 may be, as examples, the electrical components of an automobile, a residential load, a commercial load, etc. In general, the fuel cell stack 12 receives an incoming fuel flow at its anode inlet 14 from a fuel source subsystem 20. The fuel source subsystem 20 may include, as examples, a container of hydrogen, a reformer, etc., as well as the various control, supply and relief valves used to conduct the fuel flow from the fuel source to the anode 14 of the fuel cell stack 12. The fuel flow is routed through the anode flow channels of the fuel cell stack 12 to promote electrochemical reactions inside the stack 12 with the supplied oxidant flow.

In accordance with some embodiments of the invention, the anode flow may produce a continuous exhaust at an anode output 17 of the fuel cell stack 12. The anode exhaust may be combusted by a flare or oxidizer; or may be partially routed back to the anode inlet or another inlet of the fuel cell stack 12; as just a few examples, depending on the particular embodiment of the invention. As another example, the anode chamber of the fuel cell stack 12 may be “dead-ended,” or “dead-headed,” which means the anode chamber of the fuel cell stack 12 may not have a continuous outlet but instead may include an outlet that is intermittently purged for purposes of removing inert gases (nitrogen, for example) from the anode chamber. In some embodiments of the invention, the exhaust flow from anode output 17 (which may be a purge flow or a re-circulate flow) is routed through a cooling and water management subsystem 16 to remove product water from the flow.

The incoming oxidant flow to the fuel cell stack 12 is produced by an oxidant delivery subsystem 18, which may include, as examples, an air blower or compressor, as well as the various supply, control and relief valves used to conduct the oxidant flow to the cathode inlet 22 of the stack 12, depending on the particular embodiment of the invention. The oxidant flow that is produced by the oxidant delivery subsystem 18 is received at a cathode inlet 22 of the fuel cell stack 12 and is communicated through the oxidant flow channels of the stack 12. In this regard, the communication of the oxidant flow promotes the corresponding electrochemical reactions in the fuel cell stack 12 to produce power for the electrical load 150. In accordance with some embodiments of the invention, the fuel cell stack 12 includes a cathode outlet 24, at which appears the corresponding cathode exhaust from the cathode chamber of the fuel cell stack 12.

The cooling and water management subsystem 16, in general, regulates the temperature of the fuel cell stack 12 and controls the amount of product water in the system 10. More specifically, the subsystem 16 includes a reservoir 26, which stores water that is communicated through the fuel cell stack 12 for purposes of regulating the stack's temperature. In this regard, the subsystem 16 supplies the water flow to a coolant inlet 28 of stack 12. The water flows through the coolant channels within the stack 12 and exits the stack 12 at a coolant outlet 30 where the water flow is directed back to the subsystem 16 and into the reservoir 26.

In accordance with some embodiments of the invention, a vent line 32 extends from the coolant and water management subsystem 16. The vent line 32 vents the vapor portion of the cathode exhaust and the vapor portion of the anode exhaust. In some embodiments of the invention, a flammable gas, such as hydrogen, may be contained in the exhaust from vent line 32. An accumulation of flammable gas emitted from the vent line 32, as well as flammable gas emitted from other sources within system 10 (such as the fuel cell stack 12), may be managed, in part, by a ventilation system 34 which creates an air flow to dilute the concentration of flammable gas, as will be explained more fully below.

The electrical power that is generated by the fuel cell stack 12 is typically in the form of a DC stack voltage, which is received by power electronics 36 and transformed into the appropriate AC or DC voltage for the load 150, depending on the particular application. In this regard, the power electronics 36 may include, as examples, various power conditioning circuitry such as one or more switching converter stages, an inverter, etc., as can be appreciated by those skilled in the art.

In accordance with some embodiments of the invention, the system 10 and load 150 may be portable, or mobile, and more particularly may be (as an example) part of a motor vehicle 5 (a car, truck, airplane, etc.). Thus, the system 10 may serve as at least part of the power plant (represented by the load 150) of the vehicle. In other embodiments of the invention, the system 10 and load 150 may be part of a stationary system. For example, the system 10 may supply all or part of the power needs of a house, electrical substation, backup power system, etc. Additionally, the system 10 may supply thermal energy to a thermal energy consuming load (water heater, water tank, heat exchanger, etc.), and thus, electrical as well as thermal loads to the system are also envisioned. Therefore, many different applications of the system and loads that consume energy from the system are contemplated and are within the scope of the appended claims.

Due to the presence of fuel (hydrogen, for example) in the system 10, the environment in which the system 10 operates may be considered a potentially flammable or hazardous environment. For example, the environment may be classified as a class one, zone two environment. Thus, care must be undertaken to ensure that any unclassified electrical infrastructure of the system 10 is not energized or operated in the potential presence of a flammable concentration of gas. One approach is to ensure that all electrical components of the fuel cell system 10 are “classified,” which means that the components are each safe to energize in the presence of a flammable concentration of gas. However, an approach in accordance with the invention includes the use of both classified equipment 40 and unclassified equipment 42, which are arranged in an enclosure and controlled and ventilated pursuant to a technique to ensure that system 10 may be started up and operated safely.

More specifically, in accordance with some embodiments of the invention, upon the start up of the system 10, the system 10 controls the communication of electrical power from an energy source 38, which, should no flammable gas concentration be detected, supplies electrical power to the classified 40 and unclassified 42 equipment of the system 10. The energy source 38 may be, as examples, a battery that is charged during normal operation of the system 10 and/or may be an energy source (such as a wall AC source, for example) that is independent of the operation of the system 10 altogether. The particular form of the energy source 38 is not important to the aspects of the invention that are described herein.

The classified equipment 40 receives the power from the energy source 38 upon start up and controls the communication of power from the energy source 38 to the unclassified equipment 42 such that the unclassified equipment 42 is not powered up should the classified equipment 40 detect a flammable concentration of gas.

Thus, at start up from a powered-down state, the classified equipment 40 is first powered up and has the ability to detect flammable gas in the vicinity of a detector, such as a hydrogen detector 44. The major unclassified system electronics are at this point completely disengaged from any source of energy. If the detector 44 of the classified equipment 40 detects a hazard (which may be a flammable gas concentration hazard or other fault, as described herein), the equipment 40 does not allow power to be communicated from the energy source 38 to the unclassified equipment 42, and the classified equipment 40 also powers down.

If, however, the classified equipment 40 fails to detect any flammable hazard, the classified equipment 40 closes a power transfer switch 46 for purposes of allowing communication of power from the energy source 38 to the power system bus 48 (e.g., a DC bus), which supplies power to the unclassified equipment 42.

The unclassified equipment 42 includes a control subsystem 50, which as its name implies, generally controls the operations of the system 10. In this regard, the control subsystem 50 includes various input lines 52 and output lines 54 for purpose of controlling valves, motors, currents, voltages and sensing various parameters from the system 10. In accordance with some embodiments of the invention, the control subsystem 50 may monitor the output of the flammable gas detector 44 of the classified equipment 40 to ensure overall safe operation of the system 10. Once energized and active, the control subsystem 50 gains the ability to de-energize the entire system 10 including the classified 40 and unclassified 42 equipment, as further described in U.S. patent application Ser. No. ______, entitled “STARTUP CIRCUIT FOR ELECTRONICS IN A HAZARDOUS ENVIRONMENT,” which is being filed concurrently herewith and is hereby incorporated by reference in its entirety.

At any time during its operation, should the classified equipment 40 detect a predetermined hazard level, the equipment 40 may also de-energize the entire system 10, including all of the classified equipment 40 and the unclassified equipment 42.

Thus, the energization of the unclassified equipment 42 is cascaded with the energization of the classified equipment 40. In other words, the unclassified equipment 42 cannot be energized without the classified equipment 40 being energized and active. In this way, the system 10 may be de-energized by de-energizing the primary, classified equipment 40 only. It is noted that in order to de-energize the classified equipment 40, the unclassified equipment 42 may only de-energize itself, with the classified equipment 40 being de-energized as a consequence. Thus, the architecture that is described herein presents a simple way to control the state of the unclassified equipment 42 by a single circuit.

Among the other features of the fuel cell system 10, in accordance with some embodiments of the invention, the unclassified equipment 42 of the system 10 may include various additional equipment, such as sensors 56 to sense various currents, voltages, pressures, etc. and provide these indications to the control subsystem 50 as well as to the classified equipment 40. The unclassified equipment 42 may also include a cell voltage monitoring circuit 58, which scans the cell voltages of the fuel cell stack 12 for purposes of providing statistical information and measured cell voltages to the control subsystem 50. In other embodiments of the invention, the unclassified equipment 42 does not include the cell voltage monitoring circuit 58 and may, for example, include an analog circuit to measure the stack voltage.

In addition to controlling the startup and operation of the system 10 to avoid energization of system 10 in the presence of a hazardous environment, the various equipment and components of system 10 may be physically arranged in an enclosure or chassis in a manner to ensure that an accumulation of flammable gas in the enclosure either prior to startup or during operation may be avoided. In conjunction with the physical arrangement of components, buoyancy and ventilation paths may be provided to ensure that flammable gas does not accumulate in the enclosure in regions occupied by the unclassified equipment 42 either while system 10 is de-energized or operating.

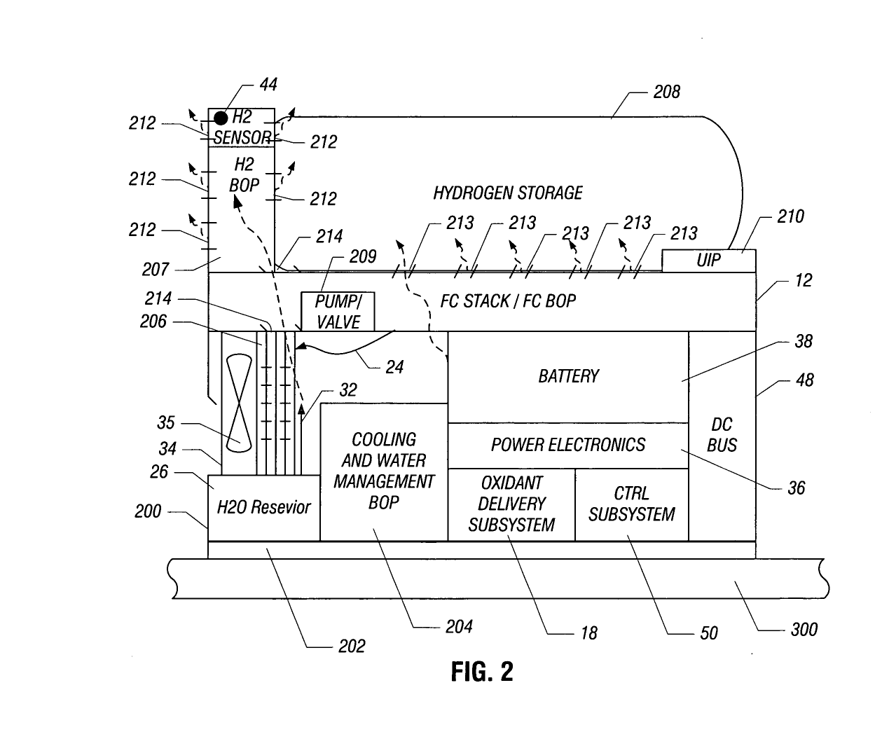

More specifically, turning to FIG. 2, an exemplary embodiment of a physical arrangement of the various components of a fuel cell-based system 10 is represented. In FIG. 2, the system 10 is shown in a de-energized state so that the buoyancy path for any flammable gas leaked or otherwise emitted from any components may be illustrated. In the embodiment shown, the buoyancy path is configured for a gas that has a positive buoyancy (i.e., is lighter than air), such as hydrogen. In systems in which gas that is heavier than air is present (i.e., has a negative buoyancy), a buoyancy path may be provided that takes into account the negative buoyancy of the gas.

In FIG. 2, the components of system 10 are arranged in an enclosure or chassis 200 having a support or base 202. These components include both classified 40 and unclassified 42 equipment, including components that may leak or otherwise emit a flammable gas even when not in an energized state. In the embodiment shown, the components within the enclosure 200 include the energy source 38 (e.g., a battery), the power electronics 36, the control subsystem 50, the DC bus 48 connecting the battery 38 to other components of system 10, the oxidant delivery subsystem 18, circuitry associated with cooling and water management subsystem 16 and other auxiliary air/thermal management circuitry (i.e., air/thermal Balance of Plant (BOP) 204), heat exchangers 206, the water reservoir 26, the vent line 32, the ventilation system 34 including a fan 35, the fuel cell stack 12 together with its Balance of Plant (BOP) (e.g., pump/valve 209, portions of cooling system 16, etc.), the hydrogen detector 44, and various components and circuitry (i.e., H2 BOP 207) associated with the fuel flow source 20 for the purposes, for example, of conducting a fuel flow from a fuel storage tank 208. In the embodiment shown, a user interface panel 210 is located outside of the enclosure 200, but also may be enclosed depending on the particular configuration and application for system 10.

Certain components of the system 10 may leak or otherwise emit a flammable gas even when the system 10 is not energized. Such components may include, for example, the battery 38 and the fuel cell stack/fuel cell BOP 12 which may leak hydrogen either from the stack/BOP 12 region itself or from the vent line 32. The emission of flammable gas from stack 12, vent 32, and battery 38 are represented in FIG. 2 by wavy dashed line arrows. Accumulation of the emitted flammable gas in regions in which the unclassified equipment 40 is located can create a hazardous situation if the equipment 40 is energized in the presence of the gas.

To address this situation, in the embodiment shown, the classified 40 and unclassified 42 equipment, including components which are capable of emitting flammable gas, are arranged relative to each other within enclosure 200 to reduce the risk that the unclassified equipment 42 will be exposed to a flammable gas when the system 10 is energized. More specifically, the unclassified equipment 42, including the power electronics 36, DC bus 48, oxidant delivery subsystem 18, control subsystem 50, and air/thermal BOP 204 are located (relative to the base 202) below the components capable of emitting a flammable gas, such as the fuel cell stack/BOP 12 and the battery 38. In addition, the enclosure 200 is provided with various apertures 212 and 213 located above the components capable of emitting a flammable gas. For a lighter than air flammable gas, such as hydrogen, the gas will rise to the highest point in the enclosure 200. Thus, when the enclosure is resting on its base 202, a buoyancy path is created via which the flammable gas will rise from the components emitting the gas and escape from the enclosure 200 without entering the region within enclosure 200 in which the unclassified equipment 42 is located. To ensure that emitted flammable gas, such as hydrogen emitted from the vent 32, is buoyantly conveyed out of the enclosure 200 through the apertures 212 and 213, the buoyancy path includes baffles 214 to direct the gas. Thus, the arrangement of equipment and the buoyancy path work in conjunction to effectively isolate the unclassified equipment 42 from the flammable gas by minimizing the potential exposure of the unclassified equipment 42 to the flammable gas.

For the positive buoyancy path to remain effective, the enclosure 200 should be in an upright position, preferably with the base 202 being supported by a surface or support structure 300. For instance, in embodiments in which the system 10 serves as part of the power plant of a vehicle 5, the support structure 300 may be part of the chassis of the vehicle 5. Accordingly, in some embodiments, the control subsystem 50 may include various interlock circuitry, such as a tilt switch that indicates that the system 10 is not in an upright position, that will prevent energization of system 10 even if the detector 44 fails to detect an abnormal concentration of a flammable gas.

In the embodiment shown in FIG. 2, the shaded areas represent the regions within the enclosure 200 in which emitted flammable gas may be present. The hydrogen sensor 44 is located in the buoyancy path and preferably is located at the highest point in the enclosure 200 relative to the base 202. The buoyancy path through the baffles 214 guides emitted flammable gas to the hydrogen detector 44. Preferably, the path is configured and the sensor 44 is located within the buoyancy path such that the gas will buoyantly reach the sensor 44 at least at the same time as it would reach the region in which the unclassified equipment 42 is located. Because of the placement of the sensor 44 in the buoyancy path, the system 10 will not start up in the event that the sensor 44 detects an unacceptably high concentration of flammable gas (e.g., a level of 10,000 ppm).

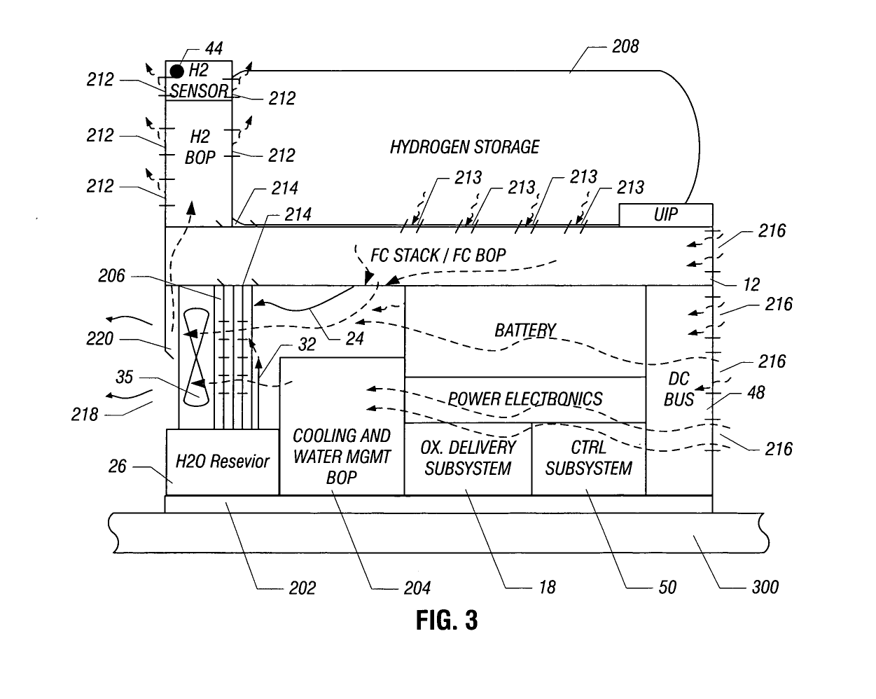

If the sensor 44 does not detect an unacceptable concentration of flammable gas, then energization of system 10 is completed, including energization of the unclassified components 42 and the ventilation system 34. The ventilation system 34 includes the fan 35, which, when energized, creates an air path through the enclosure 200 via which air is pulled into the enclosure 200 through apertures 213 and 216 and pushed out through exhaust outlet 218. In FIG. 3, the air flow path is represented by the wavy dashed arrows. In the embodiment shown, the fan 35, the unclassified equipment 42 and the components that are capable of emitting or releasing a flammable gas (e.g., fuel cell stack/BOP 12, vent 32 and battery 38) are arranged in the air stream such that the unclassified equipment 42 is upstream of any released flammable gas within the enclosure by a component capable of emitting a flammable gas.

While operating, normal emissions of flammable gas (e.g., anode purging from the fuel cell stack/BOP 12 via the vent 32) are diluted by the air stream created by the ventilation system and escape the enclosure 200 through the exhaust outlet 218. Thus, to ensure that the detector 44 will detect an abnormal emission or otherwise unacceptable concentration of flammable gas within the enclosure 200, system 10 includes a sniffer tube or pathway 220 to divert a portion of the exhaust to the detector 44.

It is noted that the fuel cell system 10 is depicted as merely an example of one out of many possible implementations of a fuel cell system in accordance with embodiments of the invention. Thus, many variations are contemplated and are within the scope of the appended claims. While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A fuel cell system comprising:
an enclosure;
a first subsystem disposed in the enclosure, the first subsystem not classified to operate in a flammable environment;
a sensor disposed in the enclosure to detect a flammable gas;
a component disposed in the enclosure, the component capable of emitting a flammable gas; and
a buoyancy path within the enclosure to guide flammable gas emitted in the enclosure such that the flammable gas can buoyantly escape from the enclosure,
wherein the sensor is located in the buoyancy path, and wherein the buoyancy path is arranged to substantially isolate the first subsystem from the flammable gas at least until the flammable gas reaches the sensor.

2. The fuel cell system as recited in claim 1, wherein the component is a fuel cell stack.

3. The fuel cell system as recited in claim 1, wherein the first subsystem comprises an energy source to energize the fuel cell system.

4. The fuel cell system as recited in claim 3, comprising a ventilation system disposed in the enclosure to direct an air flow through a ventilation path, wherein the first subsystem is positioned in the ventilation path upstream of flammable gas emitted by the component.

5. The fuel cell system as recited in claim 4, wherein the ventilation system comprises an exhaust path to divert a portion of an exhaust of the ventilation system to the sensor.

6. The fuel cell system as recited in claim 1, wherein the flammable gas is lighter than air.

7. The fuel cell system as recited in claim 1, wherein the flammable gas is hydrogen.

8. A method usable with a fuel cell system comprising:
providing a first subsystem not classified to operate in a flammable environment;
providing a sensor to detect a flammable gas;
providing a component capable of emitting a flammable gas;
arranging the first subsystem, the sensor and the component in an enclosure such that the component is located above the first subsystem and below the sensor;
providing a buoyancy path to guide the emitted flammable gas out of the enclosure; and
using the sensor to detect whether a concentration of the flammable gas in the buoyancy path exceeds a predefined threshold.

9. The method as recited in claim 8, comprising:
energizing a first portion of the fuel cell system to determine whether a concentration of the flammable gas in the buoyancy path exceeds the predefined threshold; and
energizing a second portion of the fuel cell system based at least in part on a determination that a concentration of the flammable gas does not exceed the predefined threshold.

10. The method as recited in claim 8 comprising:
arranging a ventilation system in the enclosure;
energizing the ventilation system based at least in part on a determination that a concentration of the flammable gas in the buoyancy path does not exceed the predefined threshold; and
using the ventilation system to direct an air flow that substantially prevents exposure of the first subsystem to a flammable gas.

11. The method as recited in claim 10, comprising:
using the ventilation system to direct at least a portion of an exhaust of the air flow to the sensor; and
using the sensor to determine whether the exhaust contains a concentration of the flammable gas that exceeds the predefined threshold.

12. The method as recited in claim 11, comprising de-energizing the fuel cell system in response to a determination that the exhaust contains a concentration of the flammable gas that exceeds the predefined threshold.

13. The method as recited in claim 8, wherein the component is a fuel cell stack.

14. The method as recited in claim 13, wherein the flammable gas is hydrogen.

15. A vehicle, comprising:
a chassis; and
a fuel cell system comprising:
an enclosure;
a first subsystem not classified to operate in a flammable environment;
a sensor to detect a flammable gas; and
a component capable of emitting a flammable gas,
wherein the first subsystem, the sensor, and the component are arranged in the enclosure such that, when the fuel cell system is supported by the chassis, a buoyancy path for emitted flammable gas to escape the enclosure is provided between the component and the sensor.

16. The vehicle as recited in claim 15, wherein the buoyancy path is configured such that the first subsystem is substantially isolated from the flammable gas at least until the flammable gas is detected by the sensor.

17. The vehicle as recited in claim 15, wherein the component is a fuel cell stack.

18. The vehicle as recited in claim 15, wherein the first subsystem, the sensor, and the component are arranged in the enclosure such that the component is located above the first subsystem and below the sensor when the enclosure is supported by the chassis.

19. The vehicle as recited in claim 18, comprising a ventilation system arranged in the enclosure to direct an air flow through a ventilation path upon energization of the fuel cell system, wherein the first subsystem is positioned in the ventilation path upstream of flammable gas emitted by the component.

20. The method as recited in claim 19, wherein the ventilation system comprises an exhaust path to divert a portion of an exhaust of the ventilation system to the sensor.
